(19) United States
(12) Patent Application Publication
(10) Pub. No.: US 2014/0375193 A1
(43) Pub. Date: Dec. 25, 2014

(54) MOUNTING APPARATUS FOR STORAGE DEVICES

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventor: YU-MING XIAO, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 14/219,016

(22) Filed: Mar. 19, 2014

(30) Foreign Application Priority Data
Jun. 20, 2013 (CN) 2013102458895

(51) Int. Cl. G06F 1/16

(52) U.S. Cl. CPC G06F 1/16
USPC 312/322

(57) ABSTRACT

A mounting apparatus includes a computer case and a bracket. The computer case includes a main body and a cover attached to the main body. The main body includes a side plate. A receiving slot and a sliding slot are defined in the side plate. The cover includes a limiting piece. The bracket is used to receive a storage device and includes a rotating portion and a sliding portion. The rotating portion is moveably received in the receiving slot, and the sliding portion is slidably received in the sliding slot. The sliding portion abuts the limiting piece to prevent the bracket from moving towards the cover.

### FIELD

The present disclosure relates to mounting apparatuses, and particularly to a mounting apparatus for securing storage devices in an electronic device.

### BACKGROUND

Many personal computers include data storage devices such as hard disk drives (HDDs), floppy disk drives, and compact disc-read only memory (CD-ROM) drives. The data storage devices are received in a bracket that is attached to a computer enclosure. A very small distance is defined between the bracket and a panel of the computer enclosure, and it is inconvenient for manually servicing the storage device.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, cutaway view of a mounting apparatus in accordance with an embodiment.

FIG. 2 is similar to FIG. 1, but viewed from a different aspect.

FIG. 3 is an assembled view of the mounting apparatus of FIG. 1, but a cover of the mounting apparatus of the FIG. 1 is not shown.

FIG. 4 is an assembled view of the mounting apparatus of FIG. 1.

FIG. 5 is a cross-sectional view of FIG. 4, taken along a line V-V, and a sliding portion of the mounting apparatus is located in a bottom portion of a sliding slot of the mounting apparatus.

FIG. 6 is similar to FIG. 5, but the sliding portion is located in a middle portion of the sliding slot.

FIG. 7 is similar to FIG. 5, but the sliding portion is located in an entrance of the sliding slot.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

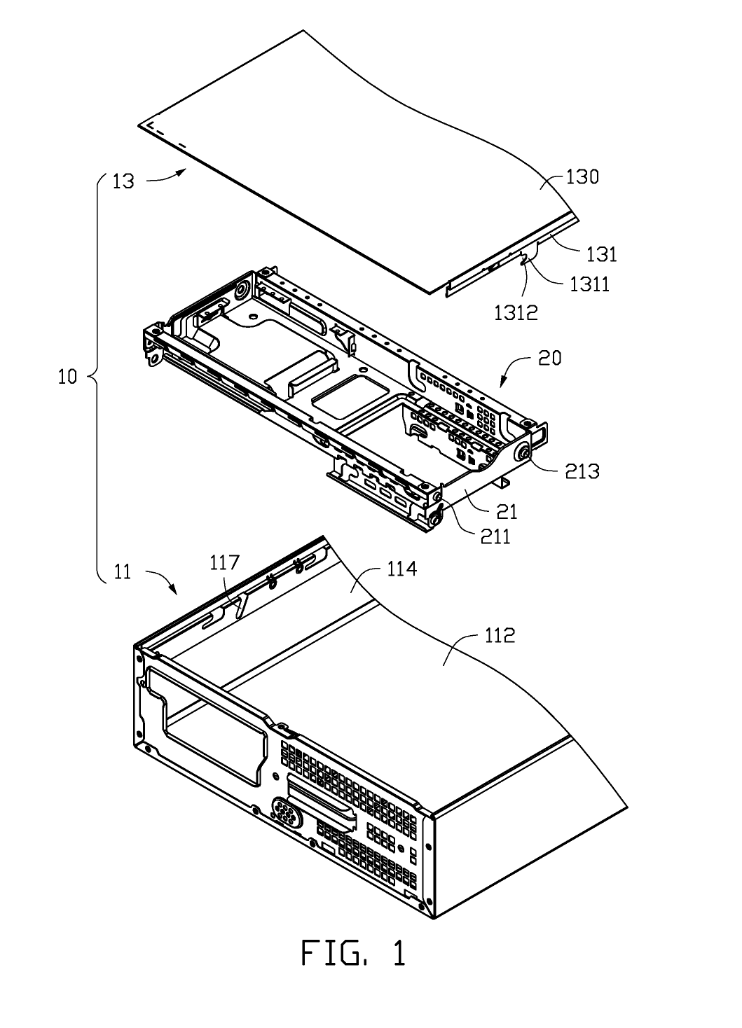

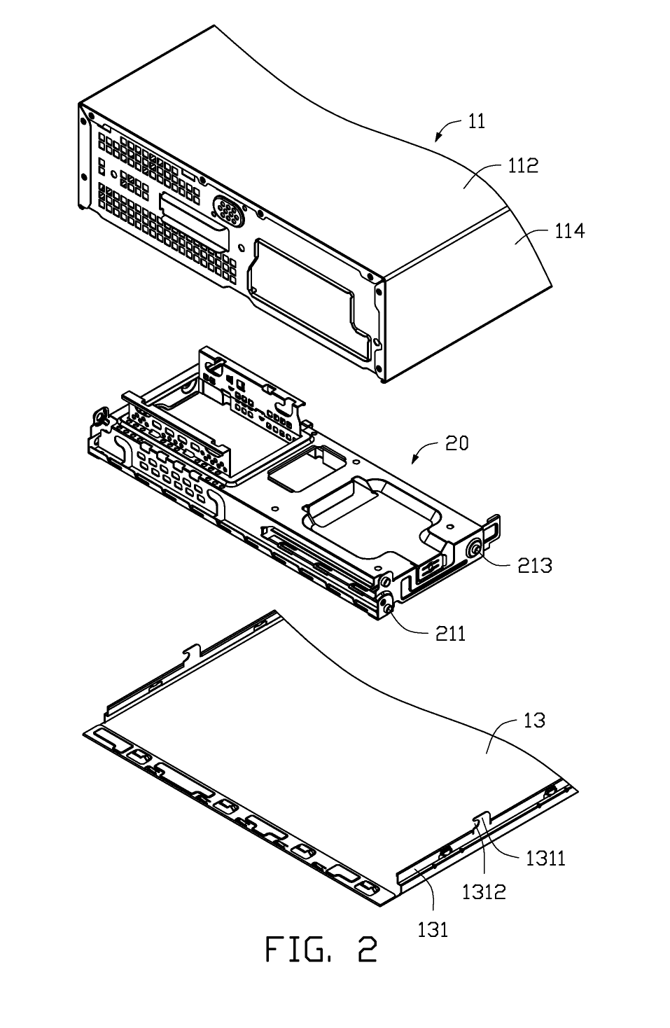

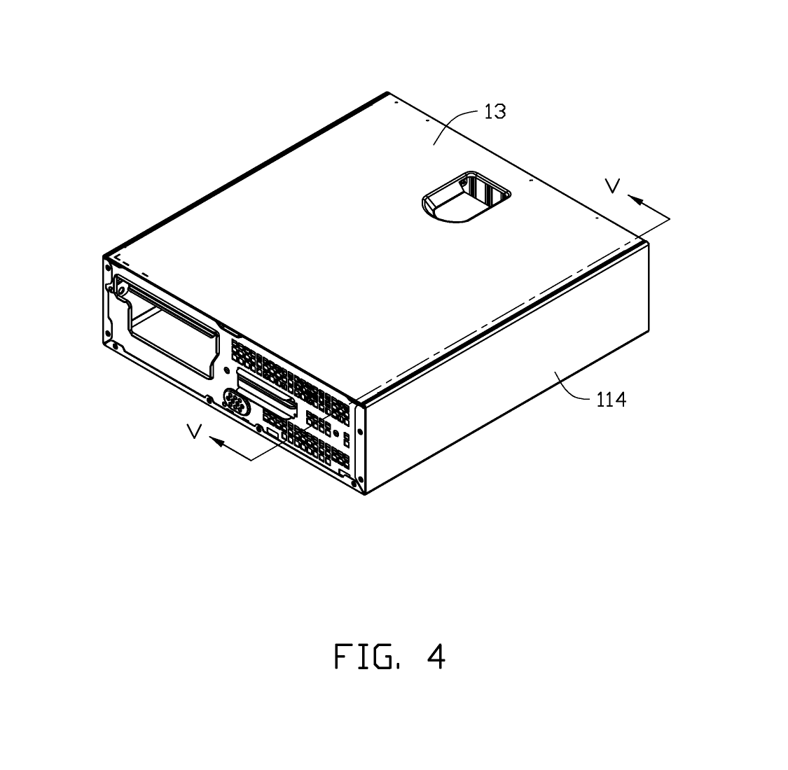

FIGS. 1-4 illustrate a mounting apparatus in accordance with an embodiment. The mounting apparatus comprises a computer case 10 and a bracket 20 attached to the computer case 10. The bracket 20 is used to receive data storage devices (not shown). The storage devices maybe hard disk drives (HDDs), floppy disk drives, and optical disk drives.

The computer case 10 comprises a main body 11 and a cover 13. The main body 11 comprises a bottom plate 112 and two side plates 114. In one embodiment, the two side plates 114 are substantially parallel to each other and perpendicular to the bottom plate 112.

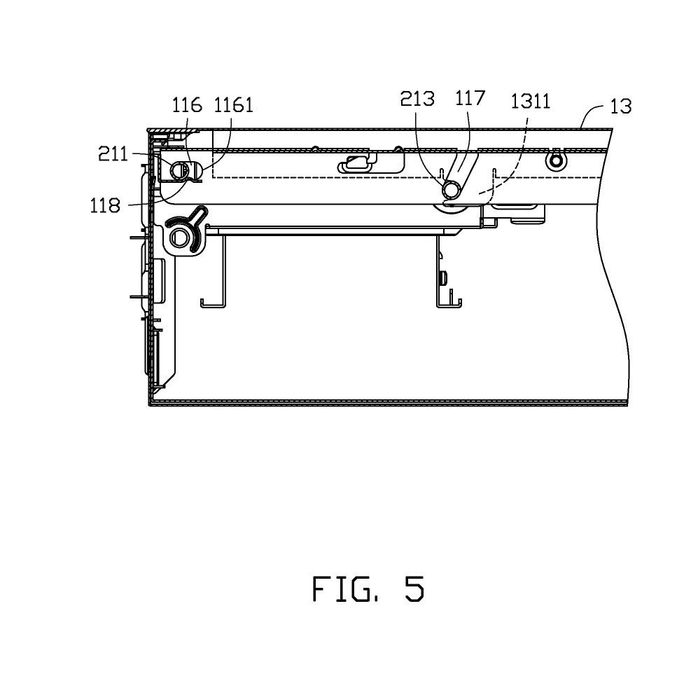

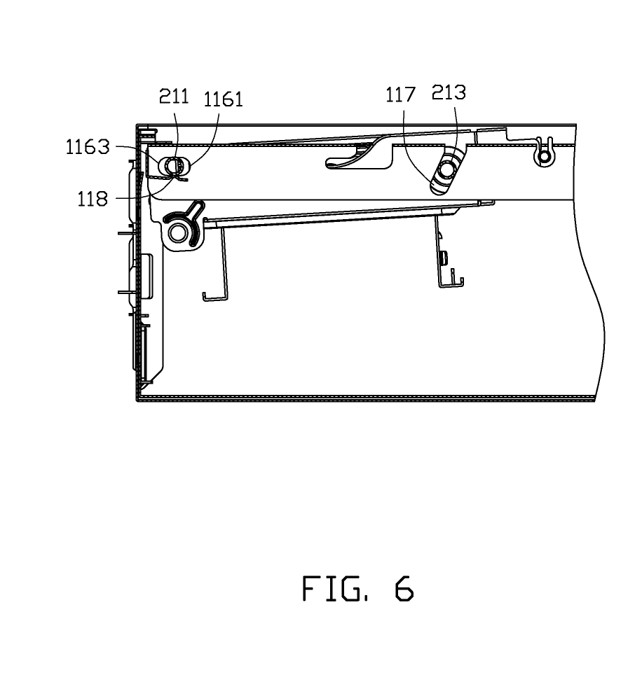

Each side plate 114 defines a receiving slot 116 (see FIGS. 5-6) and a sliding slot 117. The receiving slot 116 comprises a first end 1161 and a second end 1163 opposite to the first end 1161. A blocking portion 118 is located in the receiving slot 116 between the first end 1161 and the second end 1163. In one embodiment, the sliding slot 117 is slanted relative to a top edge of the side plate 114. The cover 13 comprises a panel 130 and two flanges 131 connected to opposite edges of the panel 130. Each flange 131 defines a limiting piece 131. In one embodiment, the limiting piece 1311 is substantially L-shaped, and a positioning slot 1312 is defined between the flange 131 and the limiting piece 1311.

The bracket 20 comprises two side panels 21. Each side panel 21 comprises a rotating portion 211 and a sliding portion 213. The rotating portion 211 corresponds to the receiving slot 116, and the sliding portion 213 corresponds to the sliding slot 117.

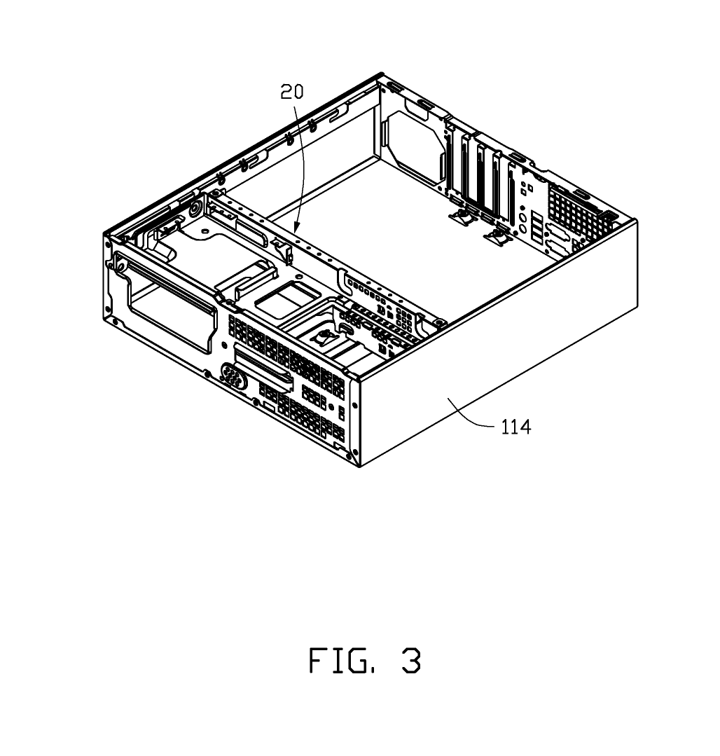

FIGS. 3-5 illustrate assembly of the mounting apparatus of an embodiment. the bracket 20 is located between the two side plates 114. Each rotating portion 21 is urged by each side plate 114 to slide into the first end 1161 of the receiving slot 116. The bracket 20 is located on an open position and substantially parallel to the side plate 114. The bracket 20 is pressed towards the bottom plate 112 rotating about an axis defined by the rotating portion 211, substantially perpendicular to the side plate 114. The rotating portion 211 is slid from the first end 1161 to the second end 1163. When the rotating portion 211 is located on the second end 1163 and the sliding portion 213 is aligned with an entrance of the sliding slot 117, the bracket 20 is further rotated to receive the sliding portion 213 in the sliding slot 117. The bracket 20 is located on a closed position.

The cover 13 covers the main body 11, and the limiting pieces 1311 are towards the sliding portions 213. The cover 13 is moved in a direction that is substantially parallel to the bottom plate 112, until the sliding portions 213 are received in the corresponding positioning slots 1312 preventing the bracket 20 from rotating upward to a position that is substantially perpendicular to the bottom plate 112.

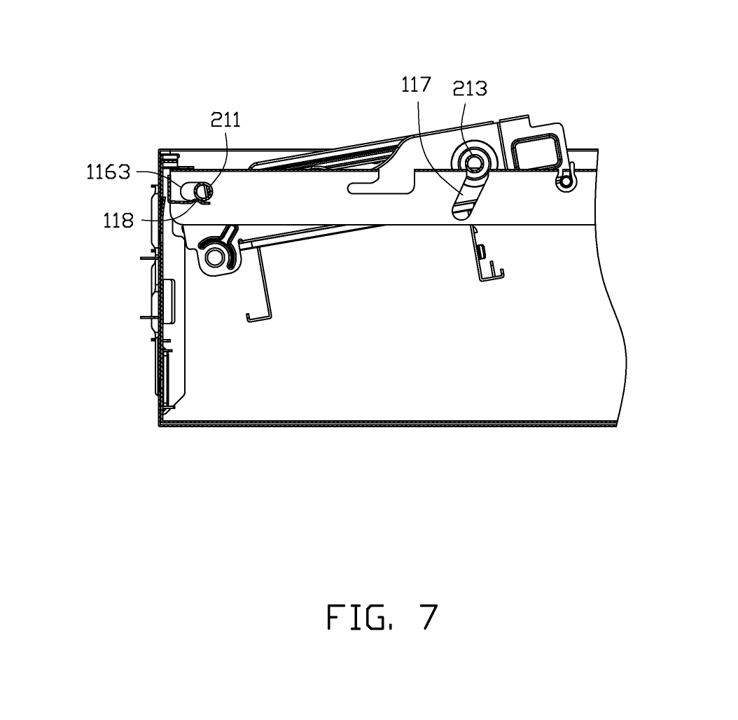

FIGS. 5-7 illustrate disassembly of the mounting apparatus of an embodiment. The cover 13 is moved in a direction that is substantially parallel to the bottom plate 112 to disengage the limiting portions 1311 from corresponding positioning slot 112, and the cover 13 is moved upward away from the main body 11. The bracket 20 is rotated to disengage the sliding portion 213 from the sliding slot 117. Simultaneously, the rotating portion 211 is slid from the second end 1163 to the first end 1161. At this time, the blocking portion 118 abuts the rotating portion 211 to prevent the rotating portion 211 from sliding from the first end 1161 to the second end 1163. The bracket 20 is rotated about the rotating portion 211 and is pulled to disengage the rotating portion 211 from the receiving slot 116, thus, the bracket 20 can be detached from the main body 11.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus comprising:
a computer case comprising a main body and a cover attached to the main body; the main body comprising a side plate; a receiving slot and a sliding slot defined in the side plate; the cover comprising a limiting piece; and
a bracket configured for receiving a storage device and comprising a rotating portion and a sliding portion; the rotating portion is moveable received in the receiving slot, and the sliding portion is slidabluy received in the sliding slot;
wherein the bracket is rotatable about the rotating portion to slide the rotating portion in the receiving slot, and when the cover is attached to the main body, the sliding portion abuts the limiting piece to prevent the bracket from moving towards the cover.

2. The mounting apparatus of claim 1, wherein the receiving slot comprises a first end and a second end opposite to the first end, when the bracket is located in an open position, the rotating portion is located in the first end; when the bracket is located in a close position, the rotating portion is located in the second end, and the sliding portion is received in the sliding slot.

3. The mounting apparatus of claim 2, wherein the side plate comprises a blocking portion, when the bracket is rotated relative to the main body, the blocking portion abuts the rotating portion to prevent the rotating portion from sliding in the sliding slot.

4. The mounting apparatus of claim 1, wherein the cover comprises a panel and a flange extending from the panel, and the limiting piece is connected to the flange.

5. The mounting apparatus of claim 4, wherein the flange is substantially perpendicular to the panel.

6. The mounting apparatus of claim 1, wherein the sliding slot is slanted relative to a top edge of the side plate.

7. The mounting apparatus of claim 1, wherein a sliding direction of the rotating portion slid in the receiving slot is substantially parallel to the side plate.

8. The mounting apparatus of claim 1, wherein the bracket is rotatable about an axis that is substantially perpendicular to the side plate.

9. A mounting apparatus comprising:
a computer case comprising a main body and a cover attached to the main body; the main body comprising a side plate; a receiving slot and a sliding slot defined in the side plate; and
a bracket configured for receiving a storage device and comprising a rotating portion and a sliding portion; the rotating portion is moveable received in the receiving slot, and the sliding portion is slidabluy received in the sliding slot;
wherein the bracket is rotatable about the rotating portion to slide the rotating portion in the receiving slot to disengage the sliding portion from the sliding slot.

10. The mounting apparatus of claim 9, wherein the cover comprises a limiting piece;
and when the cover is attached to the main body, the sliding portion abuts the limiting piece to prevent the bracket from moving towards the cover.

11. The mounting apparatus of claim 10, wherein the cover further comprises a panel and a flange extending from the panel, and the limiting piece is connected to the flange.

12. The mounting apparatus of claim 11, wherein the flange is substantially perpendicular to the panel.

13. The mounting apparatus of claim 9, wherein the receiving slot comprises a first end and a second end opposite to the first end, when the bracket is located in an open position, the rotating portion is located in the first end; when the bracket is located in a close position, the rotating portion is located in the second end, and the sliding portion is received in the sliding slot.

14. The mounting apparatus of claim 9, wherein the side plate comprises a blocking portion, when the bracket is rotated relative to the main body, the blocking portion abuts the rotating portion to prevent the rotating portion from sliding in the sliding slot.

15. The mounting apparatus of claim 9, wherein the sliding slot is slanted relative to a top edge of the side plate.

16. The mounting apparatus of claim 9, wherein a sliding direction of the rotating portion slid in the receiving slot is substantially parallel to the side plate.

17. The mounting apparatus of claim 9, wherein the bracket is rotatable about an axis that is substantially perpendicular to the side plate.
